(19) United States
(12) Patent Application Publication
(10) Pub. No.: US 2008/0203845 A1
(43) Pub. Date: Aug. 28, 2008

(54) Insulating Mask Arrangement, Armature and Electrical Machine

(75) Inventors: Achim Neubauer, Sinzheim-Vormberg (DE); Werner Herm, Buehl (DE); Pascal Chaumet, Hagenau (FR); Dirk Altmeyer, Buehl (DE); Helmut Huber, Achern (DE); Axel Diederichs, Buehl (DE)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 11/915,858

(22) PCT Filed: May 3, 2006
(86) PCT No.: PCT/EP06/61995

§ 371 Date: Nov. 29, 2007

(30) Foreign Application Priority Data
Jul. 1, 2005 (DE) 10 2005 030 872.4

(51) Int. Cl. H02K 3/34

(52) U.S. Cl. 310/215

(57) ABSTRACT

The invention relates to an insulating mask arrangement for electrically insulating an electric winding from an iron core (13) of an electrical machine (20), at least one mask element (11, 12) being arranged on the iron core (13). The invention provides that the iron core (13), in its axial extension (15), is covered throughout in its winding-guiding grooves (24) by one or more mask elements (11, 12). The invention also relates to an armature and to an electrical machine.

### BACKGROUND OF THE INVENTION

The invention relates to an insulating mask arrangement, an armature and an electric machine.

Armatures of electric machines, in particular small electric motors, which are operated in water, generate hydraulic losses due to their rotation, and these losses increase disproportionately to the speed. Normal armatures having an iron core, shaft, groove insulation, commutator and winding generate high hydraulic losses, because above all the groove openings act like blades and generate strong turbulence. The usual solution to avoiding the hydraulic losses is completely coating the armature on its outer circumference. The subsequently cylindrical lateral surface generates considerably lower turbulence and therefore fewer hydraulic losses during armature rotation.

The insulation between the winding, in particular the usual enameling of its cooper wires, and the iron core having a shaft, however, frequently hinders reliable coating during manufacturing as well as the secure functioning of the armature. The advantage of a standard groove insulation with sintered polymer powder is namely that it is very stable with respect to the effects of temperature and mechanical loads and makes it possible to subsequently completely coat the armature in order to create a low-turbulence outer circumference. The disadvantages, however, are high costs for these types of manufacturing facilities, above all when manufacturing small unit numbers of electric machines, difficulties and high expenditures in large-scale production to achieve a geometrically precise insulation, the possibility of contaminating bearing locations, pump part receptacle surfaces or outer surfaces for sealing during complete coating by the polymerized powder as well as the resulting costs for additional work and rework.

Also known is a groove insulation with insulating masks, which are slid onto the armature shaft and cover the inner geometry of the lamellae of the iron core in the grooves and the armature shaft in the area of the winding heads. The insulating masks are normally embodied to be star-shaped. When insulating masks are used, complete coating is not practical, however, due to the risk of a winding short, i.e., from electric short circuits between the winding wire of the windings and the iron core or the shaft. Because of the injection pressures required, the enameling of the winding wires is easily damaged during coating and contact with the iron core can occur. Above all, completely coating an armature with insulating masks on a large scale with the required low cycle times and the inherently related high injection pressures cannot be represented as secure in terms of the process or it is not cost-effective because of the high cost of errors.

### SUMMARY OF THE INVENTION

An insulating mask arrangement for electrically insulating an electric winding from an iron core and/or shaft of an electric machine is proposed, in which the iron core, in its axial extension, is covered throughout in its winding-guiding grooves by one or more mask elements. A standard axial assembly play, which follows from the normal required length tolerances of the iron core, is taken in account structurally in this case. As a result of the fact that the covering is achieved throughout on the entire axial extension, there are no areas in which winding wires of the windings rest directly on the iron core or the shaft, rather [they rest] exclusively on the electrically insulating mask elements. As a result, no winding shorts can occur even in the case of the normal high injection pressures when completely coating the armature.

Assuring freedom from short circuits between the iron core and/or the shaft and the winding wire embodied as a copper enameled wire requires only a simple process—only the insulating mask arrangement has to be applied—and low investment costs. Subsequent complete coating of the armature is possible in a process-reliable manner on a large scale even with low cycle times and high injection pressures.

In a first favorable embodiment, a first mask element and a second mask element, which are respectively inserted into the iron core from a first and second front side of the electric machine, overlap in an overlapping region within the axial extension of the iron core on their free ends that face away from the front sides. As a result, this assures that no gap is created on impact, in which the winding wires can be pressed against the iron core in the gap when injecting the complete coating, thereby damaging the electrical insulation of the winding wires. In addition, more than two mask elements may be used, which are arranged overlapping one another.

The overlapping region can be arranged preferably in the center in the axial extension. This is especially favorable for large armature lengths or iron core lengths.

As an alternative, the overlapping region can be arranged eccentrically in the axial extension and in a direction facing away from the injection side for injecting an injection material to completely coat the iron core on its outer circumference.

In a favorable embodiment, one of the mask elements can have a shoulder on its free end, behind which the free end of the other mask element can grip.

In a favorable embodiment, the mask elements can be embodied identically, wherein their free ends run out alternatively diagonally in the direction of the inside diameter and/or outside diameter. As a result, the mask elements can be manufactured more cost-effectively and be used reliably free of mix-ups.

In another favorable embodiment, instead of a ramp profile in the axial direction, the free ends of the mask elements can be embodied by a crown profile with diagonals to overlap perpendicularly to the axial direction.

The mask elements can engage advantageously with one another, thereby preventing the mask elements from slipping apart in the direction of the armature axis during injection.

In an alternative favorable embodiment, the mask element passes through the axial extension of the iron core and engages in the region of one of the front sides in an electrically insulating connector element that is arranged there on the front side. This embodiment is especially favorable for relatively short axial extensions of the iron core as well as for insulating arrangements in which mask elements with sufficiently large wall thicknesses can be used.

In a favorable embodiment, the electrically insulating connector element can be embodied as an insulating star.

The electrically insulating connector element can also be formed by a sintered polymer powder coating and/or by insulating paper.

In a favorable embodiment, the at least one mask element can be embodied as a star-shaped insulating star.

To prevent slipping apart in the direction of the armature axis, the at least one mask element can be advantageously arranged in press fit on the iron core.

An electric machine as well as an armature with an insulating mask arrangement is also proposed, in which the winding-guiding grooves are completely covered in their axial extension by one or more mask elements. The electric machine is preferably a fuel pump. In this case, it is expedient for fuel-resistant material to be selected for the mask elements. Likewise, selecting a wall thickness for the mask element that is as thin as possible is advantageous so that it is technically feasible for the large-scale production process and still makes the highest possible copper space factors for winding possible in order to facilitate a high degree of efficiency of the electric machine.

Hot-runner or cold-runner injection molding methods can be used advantageously for the complete coating, wherein direct injection or even injection with scrap or an injection runner is possible. A completely coated armature with a low-turbulence outer circumference can be manufactured in manner that is reliable in terms of the process.

Even with the occurrence of very high injection pressures during complete coating and unfavorable tolerance positions of the mask elements, insulating stars as well as the iron core, the invention favorably prevents contact between winding wires and the iron core or shaft. Additional costs as compared with conventional insulating masks for large-scale production are very low at best. In addition, these types of mask elements can be coated without difficulty and without scrap and/or using a direct injection process since the injection pressure does not have to be reduced during injection to avoid damaging the enameling of the winding wires.

### BRIEF DESCRIPTION OF THE DRAWINGS

Additional embodiments, aspects and advantages of the invention are also yielded independent of their summarization in the claims, without restricting universality, from the following on the basis of exemplary embodiments of the invention depicted in the drawings.

The drawings in the following show:

FIG. 1 A section through a preferred electrical machine with a preferred insulating mask arrangement;

FIG. 2 A detail of an overlapping area of two mask elements of a preferred insulating mask arrangement from FIG. 1;

FIG. 3 A section through the iron core from FIG. 1.

### DETAILED DESCRIPTION

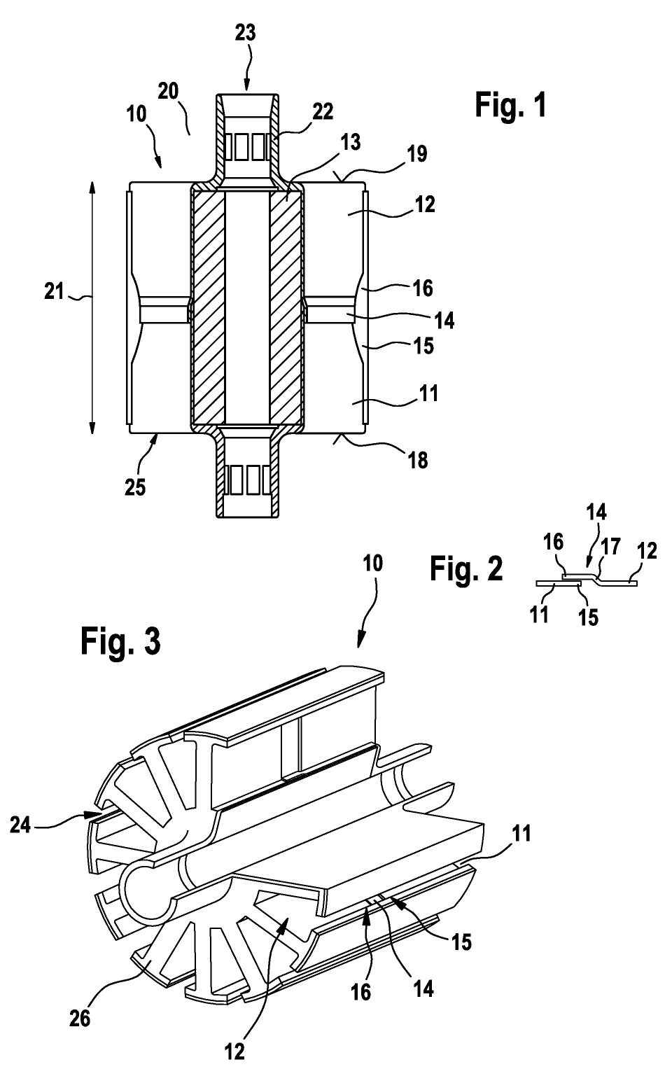

FIG. 1 shows a section through a preferred insulating mask arrangement 10 for electrically insulating winding wires of an electrical winding from an iron core 13 of an armature 25 of an electric machine 20 having a shaft 22. Mask elements 11, 12 are inserted into grooves of the iron core 13 formed of sheet metal lamellae, and said mask elements overlap with their free ends 15, 16 in an overlapping region 14. FIG. 2 shows a detailed section of the overlapping region 14 of the free ends 15, 16 of the mask elements 11, 12. The overlapping region 14 is arranged in the center in the axial extension 21 of the iron core 13 and features a ramp profile in the axial direction 23.

The mask elements 11, 12 cover the iron core 13 in its axial extension 21 throughout in its winding-guiding grooves. In the process, the first mask element 11 is inserted into the iron core from a first front side 18 and the second mask element 12 from a second front side 19 of the iron core 13. The second mask element 12 has, on the entire groove inside geometry, a shoulder 17 on its free end 16 such that the first mask element 11 always lies beneath the second mask element 12 and is thereby covered. The second mask element 12 is mounted on the armature side, which forms an injection side 26 with injection points (FIG. 3), into which plastic is injected in an armature complete coating tool. The plastic then flows first on the second mask element 12 and then on the first mask element 11. Since an assembly play area lies in the overlapping region 14, plastic hardly penetrates there, and no larger quantities of plastic can flow between the groove inside geometry and the first mask element 11. The first mask element 11 remains undamaged, and the usual copper enamel wires of a winding of the armature 25 are always pressed against an electrically insulating surface of the mask elements 11, 12, by the injection forces and not on the bare iron core 13.

FIG. 3 shows a first mask element 11 and a second mask element 12, which are respectively inserted into the iron core 13 from a first and second front side 18, 19 of the electric machine 20, overlapping in an overlapping region 14 within the axial extension 21 of the iron core 13 on their free ends 15, 16 that face away from the front sides 18, 19. The injection side 26 is on the front left in this figure.

1. Insulating mask arrangement for electrically insulating an electric winding from an iron core (13) of an electric machine (20), wherein at least one mask element (11, 12) is arranged on the iron core (13), characterized in that the iron core (13), in its axial extension (21), is covered throughout in its winding-guiding grooves (24) by one or more mask elements (11, 12).

2. Insulating mask arrangement according to claim 1, characterized in that a first mask element (11) and a second mask element (12), which are respectively inserted into the iron core (13) from a first and second front side (18, 19) of the electric machine (20), overlap in an overlapping region (14) within the axial extension (21) of the iron core (13) on their free ends (15, 16) that face away from the front sides (18, 19).

3. Insulating mask arrangement according to claim 2, characterized in that the overlapping region (14) is arranged in the center in the axial extension (21).

4. Insulating mask arrangement according to claim 2, characterized in that the overlapping region (14) is arranged eccentrically in the axial extension (21) and in a direction facing away from the injection side (26) for injecting an injection material to completely coat the iron core (13) on its outer circumference.

5. Insulating mask arrangement according to claim 2, characterized in that one of the mask elements (12) has a shoulder (17) on its free end (16), behind which the free end (15) of the other mask element (11) can grip.

6. Insulating mask arrangement according to one of claims 2 4, characterized in that the mask elements (11, 12) are embodied identically, wherein their free ends (15, 16) run out alternatively diagonally in the direction of the inside diameter and/or outside diameter.

7. Insulating mask arrangement according to one of claims 2 4, characterized in that the mask elements (11, 12) can engage with one another.

8. Insulating mask arrangement according to claim 1, characterized in that the mask element (11, 12) passes through the axial extension of the iron core (13) and engages in the region of one of the front sides (18, 19) in an electrically insulating connector element.

9. Insulating mask arrangement according to claim 7, characterized in that the electrically insulating connector element is embodied as an insulating star.

10. Insulating mask arrangement according to claim 7, characterized in that the electrically insulating connector element is formed by a sintered polymer powder coating and/or by insulating paper.

11. Insulating mask arrangement according to claim 1, characterized in that the at least one mask element (11, 12) is embodied as a star-shaped insulating star.

12. Insulating mask arrangement according to claim 1, characterized in that the at least one mask element (11, 12) is arranged in press fit on the iron core (13).

13. Armature of an electric machine with an insulating mask arrangement (10) for electrically insulating an electric winding from an iron core (13) of an electric machine (20), wherein at least one mask element (11, 12) is arranged on the iron core (13), characterized in that the winding-guiding grooves (24) are completely covered in their axial extension (21) by one or more mask elements (11, 12).

14. Electric machine with an insulating mask arrangement (10) for electrically insulating an electric winding from an iron core (13) of an electric machine (20), wherein at least one mask element (11, 12) is arranged on the iron core (13), characterized in that the winding-guiding grooves (24) are completely covered in their axial extension (21) by one or more mask elements (11, 12).
